(19) United States
(12) Patent Application Publication
(10) Pub. No.: US 2005/0036557 A1
(43) Pub. Date: Feb. 17, 2005

(54) Method and system for time synchronized forwarding of ancillary information in stream processed MPEG-2 systems streams

(76) Inventors: Jeyendran Balakrishnan, San Jose, CA (US); Hemant Malhotra, Fremont, CA (US)

Correspondence Address: PROSKAUER ROSE LLP;PATENT DEPARTMENT, 1585 BROADWAY, NEW YORK, NY, 10036-8299, US

(21) Appl. No.: 10/641,323

(22) Filed: Aug. 13, 2003

(51) Int. Cl. H04N 7/12

(52) U.S. Cl. 375/240.28

(57) ABSTRACT

A method and system are provided for processing an elementary stream in a systems layer stream that is presumed to be ultimately consumed according a to predefined and deterministic schedule relative to a particular system time clock of a program that comprises the elementary stream. First and second synchronization points are identified in an elementary stream. The elementary stream is processed to produce a modified sequence of elementary stream information to be carried between the first and second synchronization points. The modified sequence has a different amount of information than the particular sequence of information. A series of one or more new systems layer stream segments carrying the first synchronization point, as well as the modified sequence of elementary stream information, are inserted into a new systems layer stream. At least one of the new systems layer stream segments comprises a systems layer information sub-segment containing the particular ancillary data. Each synchronization point is a type of sequential location of the elementary stream: (1) which recurs continually throughout the elementary stream; (2) is synchronized in time to the systems time clock of the program containing the elementary stream; and (3) is always present in an elementary stream both prior to, and after, the processing.

### RELATED APPLICATIONS

The subject matter of this application is related to the subject matter of the following U.S. patent applications, all of which are commonly assigned to the same assignee as is this application:
(1) U.S. patent application Ser. No. ______ , (Docket No.: 68775-049) filed concurrently herewith for Jeyendran Balakrishnan and Shu Xiao and entitled Method And System For Modeling The Relationship Of The Bit Rate Of A Transport Stream And The Bit Rate Of An Elementary Stream Carried Therein;
(2) U.S. patent application Ser. No. ______ , (Docket No.: 68775-050) filed concurrently herewith for Jeyendran Balakrishnan and Shu Xiao and entitled Model And Model Update Technique In A System For Modeling The Relationship Of The Bit Rate Of A Transport Stream And The Bit Rate Of An Elementary Stream Carried Therein;
(3) U.S. patent application Ser. No. ______ , (Docket No.: 68775-051) filed concurrently herewith for Jeyendran Balakrishnan and Hemant Malhotra and entitled Method And System For Re-Multiplexing Of Content-Modified MPEG-2 Transport Streams Using PCR Interpolation; and
(4) U.S. patent application Ser. No. ______ , (Docket No.: 68775-055) filed concurrently herewith for Jeyendran Balakrishnan and Hemant Malhotra and entitled Method and System for Re-multiplexing of Content Modified MPEG-2 Transport Streams using Interpolation of Packet Arrival Times.
   The contents of the above-listed patent applications are incorporated herein by reference.

### FIELD OF THE INVENTION

The present invention pertains to signals which are hierarchically organized into a systems layer stream and a lower layered elementary stream, where an elementary stream is information intended to be consumed according to a very strict, deterministic schedule. An example of such an elementary stream is a “media signal” component of a program, such as an audio signal or a video signal. Examples of systems layer streams include an MPEG-2 transport stream, and MPEG-2 packetized elementary stream (PES) or an MPEG-2 program stream. Examples of consumption include, transferring portions of the elementary stream or systems layer stream into a buffer, removing portions of the elementary or systems layer stream from a buffer, decoding a portion of the elementary stream and/or presenting a decoded version of the elementary stream portion. In particular, the invention pertains to maintaining time synchronization of ancillary information carried in the systems layer stream in the event that the amount of information in portions of the elementary stream are modified or shifted by stream processing operations, such as transcoding, splicing, or editing the elementary stream.

### BACKGROUND OF THE INVENTION

A program signal is composed of one or more component signals referred to herein as elementary streams. An example of an elementary stream can be one (natural or synthetic) audio signal, one (natural or synthetic) video signal, one closed captioning text signal, one private data signal, etc. Several techniques are known for compressing, formatting, storing and conveying such elementary streams. For example, the MPEG-1, MPEG-2, MPEG-4, H.263, H.263++, H.26L, and H.264/MPEG-4 AVC standards provide well-known techniques for encoding (compressing and formatting) video. Likewise, MPEG-1 (including the so-called “MP3”), MPEG-2, MPEG-4 and Dolby AC-3, provide techniques for encoding audio.

In addition, there are several known techniques for combining elementary streams for storage or transmission. MPEG-2 defines a technique for segmenting each elementary stream into packetized elementary stream (“PES”) packets, where each PES packet includes a PES packet header and a segment of the elementary stream as the payload. PES packets, in turn, may be combined with “pack headers” and other pack specific information to form “packs”. Alternatively, the PES packets may be segmented into transport packets of a transport stream, where each transport packet has a transport packet header and a portion of a PES packet as payload. These transport packets, as well as others (e.g., transport packets carrying program specific information or DVB systems information, entitlement management messages, entitlement control messages, other private data, null transport packets, etc.) are serially combined to form a transport stream.

In another known technique according to MPEG-4 systems, elementary streams may be divided into “sync-layer” (or “SL”) packets, including SL packet headers. SL packets may be combined with PES packet headers, to form PES packets, and these PES packets may be segmented and combined with transport packet headers to form transport packets. According to another technique, transport packets are not used. Rather, elementary stream data is segmented and real-time protocol (“RTP”) packet headers are appended to each segment to form RTP packets. In addition, or instead, user datagram protocol (“UDP”) or transmission control protocol (“TCP”) packet headers may be appended to segmented data to form UDP or TCP packets. Many combinations of the above are possible including formatting the elementary streams into SL packets first and then formatting the SL packets into RTP packets, encapsulating transport packets into TCP packets according to the so-called multi-protocol encapsulation (“MPE”), etc.

Herein, the MPEG-2 PES and transport streams encapsulating MPEG-2 video will be used as a model for illustrating the invention. Also, this invention is illustrated using a hierarchical signal, wherein elementary streams are carried as segments in packets or cells of one or more higher layers. The term “systems layer” is herein used to refer to such higher layers. The MPEG-2 PES streams and transport streams will be used as a specific example of the systems layer. However, those skilled in the art will appreciate that other kinds of hierarchical layers may be used interchangeably as the systems layer for the elementary stream, such as the SL layer, the RTP layer, etc. Furthermore, “systems layer” need not be restricted to the “transport layer” according to the OSI seven layer model but can, if desired, include other layers such as the network layer (e.g., internet protocol or “IP”), the data link layer (e.g., ATM, etc.) and/or the physical layer. Also, other types of elementary streams, such as encoded audio, MPEG-4 video, etc. may be used. In addition, the term “transmission” is used herein but should be understood to mean the transfer of information under appropriate circumstances via a communications medium or storage medium to another device, such as an intermediate device or a receiver/decoder.

FIG. 1 illustrates the hierarchical nature of the transport stream. A video elementary stream is shown which contains multiple compressed pictures or video images I0, B1, B2, P3, B4, B5, P6, B7, B8, I9. It should be noted that each picture is presented over an integer multiple of a fixed interval of time (e.g., 1, 2 or 3 field periods), but can have a variable amount of information.

Next, the video elementary stream is segmented into payloads for PES packets. PES packets can contain a fixed length segment of elementary stream information or a variable length segment of elementary stream information. In the illustration of FIG. 1, each PES packet encapsulates the encoded information of the video elementary stream representing precisely one encoded video picture. This is not a strict requirement of MPEG-2 but is a requirement of other standards such as ATSC. However, other strategies can be used for segmenting the elementary stream into PES packets. For example, each PES packet may be restricted to have a fixed number of bytes in its payload and/or a fixed total number of bytes (i.e., the sum of the number of bytes in the PES packet header and the number of bytes in the PES payload may be a fixed number). This is especially true for different kinds of elementary streams (e.g., audio, synthetic images) or for different encoded formats (e.g., for MPEG-4). Note also that the headers of PES packets can vary in size, depending on the presence or absence of other PES layer information in the PES header such as: time stamps (e.g., presentation time stamps and/or decoding time stamps), trick mode control information, copyright information, and PES extension data.

The PES packets themselves are segmented and placed into transport packets. All MPEG-2 transport packets have a fixed length of 188 bytes. A transport packet has a minimum sized header of 4 bytes followed by a payload. The PES packets are divided into segments and each segment is placed in a payload of a transport packet. However, transport packet headers can also be of variable length depending on whether or not the transport header is also carrying: program clock reference (PCR) time stamps, discontinuity information, bit rate information, splice point information, padding, etc. For example, PCRs must be delivered at least at a certain frequency. However, PCRs can be delivered more frequently and need not be delivered at precise moments in time. Therefore, under normal circumstances, PCRs may be found in transport packets, nominally at a certain frequency, or more frequently, but not precisely at any frequency. Indeed, transport packets containing PCRs are often moved relative to other transport packets containing PCRs for the same program as a result of remultiplexing.

Many standards for encoding and transmitting elementary streams have requirements for maintaining a strict schedule for delivering the elementary stream data, the systems layer stream carrying it, or both. These requirements are intended to ensure that the information is delivered in a timely fashion to enable seamless presentation. Often, such requirements are analogous to a “just-in-time” inventory system; streamed information is controlled so that it is delivered at just the right time and at just the right rate to make sure that enough stream information is available for decoding and presentation without interruption or delay. However, the delivery requirements also are intended to ensure that no more information is delivered than there is available storage capacity to hold it pending decoding and presentation. Furthermore, the systems layer signal often must meet certain bit rate requirements of the channel that carries the system layer stream, such as a maximum bit rate, a minimum bit rate or even a certain constant bit rate. As such, bit rates of both elementary and systems layer streams must be carefully controlled from production to consumption. In addition, various time stamps, such as program clock references (PCRs) or system clock references (SCRs) are placed in the systems layer signal at very precise locations to enable any device receiving the systems layer stream to reconstruct a systems time clock time base pertinent to controlling the consumption of the respective elementary stream. Additional time stamps, such as decoding time stamps (DTSs) or presentation time stamps (PTSs) may be provided which indicate specific times at which clearly identifiable portions of the elementary stream should be decoded and/or presented relative to the recovered system time clock. Other consumption activities are simply controlled based on the recovered system time clock and predefined rules.

In addition to elementary streams, the systems layer signals carry ancillary information which is also time sensitive. That is, such ancillary data must be consumed according to a strict deterministic schedule relative to the recovered system time clock of the (program carrying) the elementary stream carried with such ancillary information. Usually, such information is carried in the header of a systems layer segment (e.g., a pack or packet header). For example, the PES packet header may carry: PTSs, DTSs, PES scrambling control information, copyright information, private data and trick mode information. The transport stream packet header may carry: PCRS, transport scrambling control information, private data, trick mode information, splice point information, discontinuity indicators, and random access information. Pack headers may carry SCRs.

To illustrate the time sensitive nature of ancillary data consider the following examples. A PCR indicates the correct time that should read on a system time clock, recovered at a consumer of the systems layer stream, at the time the PCR is received. Therefore, the value of the PCR must reflect the presumed time of receipt of that PCR at the consumer, which in turn is a function of the transmission rate of the systems layer stream that carries it, as well as the location of that PCR within the systems layer stream. Also, PCRs must be received at a minimum frequency. In addition, it may be desired or required to insert a PCR in each systems layer packet carrying the first byte of an encoded video picture. Likewise, scrambling information may signal a switch from using one descrambling key to use of a different descrambling key. This information should be present near the appropriately scrambled information and, in any event, must be signaled at just the right time so that key recovery time is both limited to prevent unauthorized theft of information, yet sufficiently long to enable authorized key recovery. Splice, discontinuity and trick mode information often signal an impending change to the decoded elementary stream which might otherwise be considered an error. Such information often includes count-down or advance warning information, or indications that the same systems layer packet carries elementary stream data that can be used to enable quick or seamless decode/presentation transition of the elementary stream. As can be appreciated, for all of these reasons, as well as others, it is critical to synchronize the delivery or consumption of such ancillary information relative to the systems time clock and/or the elementary stream information with which it is carried.

In the MPEG-2 context, the prior art teaches a number of “stream processors” or devices that process previously generated transport streams, such as transcoders, editors and splicers. A transcoder receives an already encoded elementary stream and re-encodes it, e.g., at a different bit rate, according to a different encoding standard, at a different resolution, using different encoding options, etc. A splicer is a device that appends one signal to another or inserts that signal in the middle of the first. For example, a splicer may append one encoded elementary stream at the end of another elementary stream in a program so that they will be presented seamlessly and in sequence. Alternatively, the splicer could insert one program in the middle of another, e.g., in the case of inserting a commercial in the middle of a television show. An editor is a device that edits (modifies) an elementary stream and produces an edited encoded elementary stream. Examples of these devices are described in U.S. Pat. Nos. 6,141,447, 6,038,256, 6,094,457, 6,192,083, 6,005,621, 6,229,850, 6,310,915, and 5,859,660.

In such stream processing, the underlying bit positions of various parts of the elementary stream will change. For instance, video or audio transcoding tends to change the amount of information (number of bits) needed to represent each decodable and presentable portion of the video or audio. This is especially true for a transcoder that changes the bit rate of the output signal. It is also true for a transcoder which decodes an elementary stream that was encoded according to a first standard and re-encodes that elementary stream according to a different standard. Likewise, a splice or edit tends to change the relative location of two points (namely, the end point of the original encoded video signal portion, that precedes the inserted elementary stream information, and the beginning point of the original encoded video signal portion, that follows the inserted elementary stream information) in the originally encoded elementary stream.

Such changes impact the relative synchronicity of the ancillary information formerly carried in the systems layer stream prior to processing the elementary stream. Specifically, prior to processing, the ancillary information was located in the same temporal proximity of specific portions of the elementary stream. However, the amount of information in the elementary stream is changed at various points. Likewise, the total amount of systems layer stream information needed to carry the elementary stream is likely to have changed. The ancillary information must somehow be placed into the new systems layer stream carrying the processed elementary stream so as to be in a similar vicinity to corresponding portions of the processed elementary stream, and, in any event, to be delivered at the correct rate and approximate delivery schedule.

Reinsertion of the ancillary information cannot be done by in a simple manner. As noted above, the stream processing may vary the amount of information for each portion of the elementary stream differently and in an unpredictable fashion. Therefore, it is not possible to simply attempt to measure the ratio of the number of bits of the systems layer or elementary stream prior to stream processing and the number of bits in the new systems layer or elementary stream and simply shift the ancillary data within the new systems layer stream according to this ratio. Simply stated, there is no way to know, a priori, where to insert each item of ancillary information within the new systems layer stream.

The only known technique for reinserting ancillary data is to determine the precise time of the system time clock of the (program of the) elementary stream at which each item of ancillary information occurred in the systems layer stream. Each item of ancillary information could then be inserted into the new systems layer stream at a location corresponding to the determined precise time in the incoming original systems layer stream prior to processing. However, this is a rather complicated solution requiring a sophisticated technique for recovering the system time clock from the PCRs or SCRs relevant to (the program of) each elementary stream. Also, this solution requires generation of new timing information (i.e., PCRs or SCRs) for the new systems layer stream carrying the processed elementary stream. Furthermore, this solution requires inserting the ancillary information into the new systems layer stream at the correct locations so that such ancillary information is received according to the correct schedule relative to the new system time clock.

It is desirable to provide a technique for maintaining synchronization of ancillary information in a systems layer stream after processing the elementary stream, which is less computationally intensive and therefore cheaper to implement.

### SUMMARY OF THE INVENTION

This and other objects are achieved according to the invention. According to one embodiment, a method is provided for processing an elementary stream. The elementary stream is ultimately capable of being consumed according a predefined and deterministic schedule relative to a particular system time clock of a program that comprises the elementary stream. Such a systems time clock can be recovered from a systems layer stream that carries the elementary stream. First and second synchronization points are identified in an elementary stream. The first and second synchronization points are separated by a particular sequence of information in the elementary stream. An original systems layer stream (that comprises the elementary stream) comprises a series of systems layer stream segments. Each systems layer stream segment comprises a systems layer specific sub-segment of information and one elementary stream sub-segment, of a plurality of sub-segments of elementary stream information into which the elementary stream is divided. One or more systems layer information sub-segments of a sub-series of the systems layer stream segments, that carry the first synchronization point and the particular sequence of elementary stream information, carry particular ancillary data. The elementary stream is processed to produce a modified sequence of elementary stream information to be carried between the first and second synchronization points. The modified sequence has a different amount of information than the particular sequence of information (in the original systems layer stream). A series of one or more new systems layer stream segments, carrying the first synchronization point and the modified sequence of elementary stream information, is inserted into a new systems layer stream. At least one of the new systems layer stream segments comprises a systems layer information sub-segment containing the particular ancillary data. Each synchronization point is a type of sequential location of the elementary stream: (1) which recurs continually throughout the elementary stream; (2) is synchronized in time to the systems time clock of the program comprising the elementary stream; and (3) is always present in an elementary stream both prior to, and after, the processing.

Illustratively, the first and second synchronization points are codes contained within the elementary stream. Alternatively, the synchronization points are virtual points of the elementary stream. Illustratively, the synchronization points delimit a portion of the elementary stream that is consumed at a particular scheduled time relative to the system time clock of the program comprising the elementary stream.

Examples of consumption include: (a) removing a (synchronization point delimited) portion of the elementary stream from a specific buffer at a particular scheduled time relative to the systems time clock; (b) decoding a (synchronization point delimited) portion of the elementary stream at a particular scheduled time relative to the systems time clock; and/or (c) presenting information represented by a (synchronization point delimited) portion of the elementary stream at a particular scheduled time relative to the systems time clock.

Illustratively, prior to the step of inserting, the particular ancillary data, carried in the same systems layer stream segments that also carry the particular elementary stream sequence, is identified and stored. The occurrence of the first synchronization point in the (original) elementary stream to be processed is identified, the particular ancillary data is retrieved, and one or more systems layer information sub-segments are generated containing the retrieved ancillary data. As such, a drift or error in synchronism of the particular ancillary data with the system time clock of the program is reduced by locating the ancillary data within the new systems layer stream in a similar vicinity relative to one of the first or second synchronization points as in the original systems layer stream.

Illustratively, the particular ancillary data can be distributed over multiple ones of the new systems layer stream segments. Alternatively, the particular ancillary data may be inserted into a single one of the new systems layer stream segments.

Illustratively, the frequency of occurrence of the synchronization points in the elementary stream is at least equal to the frequency of occurrence of one type of ancillary data comprised in the particular ancillary data. One or more particular types of synchronization points illustratively may be adaptively or dynamically chosen, wherein the particular types are expected to occur with sufficient frequency to use as reference points for locating the particular ancillary data in the new transport stream. According to the invention, the point in the stream at which the ancillary data is inserted into the new systems layer stream (i.e., the systems layer stream produced after performing the stream processing operation) will always lie between two synchronization points. In a worst case scenario, the ancillary data is extracted from a location (within the stream) immediately adjacent to one of the two synchronization points but inserted at a location within the new systems layer stream immediately adjacent the other of the two synchronization points. In such a case, the drift or error in synchronism of the ancillary data can be no greater than the time between the two synchronization points. Stated another way, the maximum drift or error in synchronism of the ancillary data within the new systems layer stream (after performing the stream processing operation) is bounded by the difference in time between synchronization points. Thus, the error or drift in synchronism of the ancillary data can be minimized by increasing the frequency at which synchronization points occur in the systems layer stream. This can be achieved by judicious selection of the particular types of synchronization points.

### BRIEF DESCRIPTION OF THE DRAWINGS

FIG. 1 illustrates a hierarchical organization of a transport stream.

FIG. 2 illustrates a system according to an embodiment of the present invention.

FIG. 3 shows a portion of a systems layer stream prior to stream processing.

FIG. 4 shows a portion of a systems layer stream produced by the output module 150 of FIG. 2 according to an embodiment of the present invention.

FIG. 5 shows a portion of a second systems layer stream produced by the output module 150 of FIG. 2 according to an embodiment of the present invention.

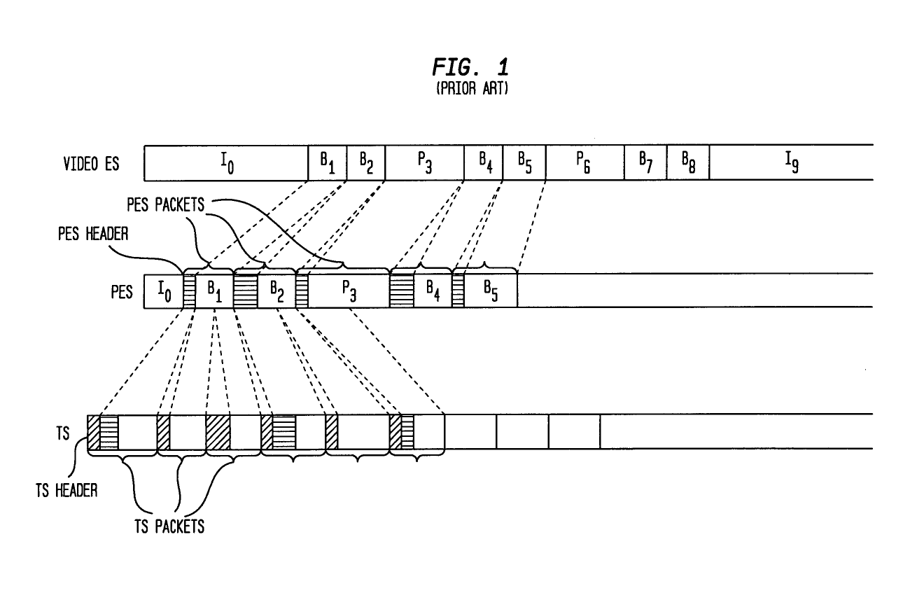

### DETAILED DESCRIPTION OF THE INVENTION

According to the invention, the input transport stream is parsed to identify “synchronization points” in the elementary stream it carries. Synchronization points are points or locations within a stream that can be used as a basis for identifying locations near which incoming ancillary data should be located in a new transport stream carrying a processed version of the incoming elementary stream. In principle, synchronization points are locations in the elementary stream which are known to bear a clear and fixed timing relationship with the system time clock of the program comprising the elementary stream and therefore can serve as a basis for retiming or re-synchronizing ancillary data to the system time clock in a sufficiently accurate fashion.

The types of synchronization points used according to the invention illustratively meet all of the following criteria:

(a) System Time Clock Correspondence:

An important underpinning of the invention is that ancillary data can be re-timed or re-synchronized in the new systems layer stream produced after stream processing by locating the ancillary data in a certain vicinity of a synchronization point of the elementary stream after stream processing (“processed elementary stream”). That is, in lieu of determining the location by direct reference to the systems time clock (which would require recovery of the systems time clock), the ancillary data is located in a vicinity of a synchronization point of the elementary stream (which in turn, is in synchronism with the system time clock of the program comprising the elementary stream). Therefore, the type of point chosen for use as a synchronization point must correspond with a particular determinable time of the system time clock of the program comprising the elementary stream, even though this particular time need not be explicitly determined.

(b) Invariance to Stream Processing:

According to the invention, ancillary data is initially located within the original systems layer stream in a certain vicinity of a specific identifiable synchronization point in the elementary stream, prior to stream processing. Likewise, after stream processing, this ancillary data should be located within the new systems layer stream in a similar vicinity to the same synchronization point of the stream-processed elementary stream. In order to enable re-locating the ancillary data in the new elementary stream, the same synchronization point must be present in the elementary stream both before stream processing and after stream processing.

(c) Continual Recurrence In The Elementary Stream:

Generally, ancillary data is expected to recur continually throughout the systems layer stream, or at least the sequence carrying the processed elementary stream. Likewise, the type of synchronization point chosen for use in the invention should also continually recur within the processed elementary stream. In other words, over the course of time, so long as information is being carried in the systems layer stream for the elementary stream to be stream processed, and so long as there is ancillary data to be retimed or re-synchronized, one should also expect to find synchronization points in the elementary stream. Otherwise, such candidate synchronization points cannot provide a suitable reference by which to relate the ancillary data.

In addition to the above criteria, it is preferable to choose a type of synchronization point that occurs frequently within the elementary stream. As will be appreciated from the description below, the higher the frequency of occurrence of the synchronization point, the more accurate will be the retiming or re-synchronizing of the ancillary data in the new transport stream carrying the processed elementary stream. More specifically, as described in greater detail below, two successive synchronization points define a temporal locale, which is a portion of an elementary stream corresponding to an elapsed duration in time of the systems time clock of the program of which the elementary stream is a component. According to the invention, ancillary data occurring in a given temporal locale (between two synchronization points) of an input systems layer stream is gathered prior to processing the systems layer stream, and the specific temporal locale in which the ancillary data was gathered, is noted. After stream processing, the corresponding temporal locale in the processed elementary stream is located, and the ancillary data is inserted into the new systems layer stream, containing the processed elementary stream, at that identified temporal locale. However, the amount of elementary stream data in a given temporal locale may change as a result of the stream processing. As such, the precise corresponding time of the systems time clock at which ancillary data may be inserted into the new systems layer stream will be different than the original time of the systems time clock of the location within the original systems layer stream from which the ancillary data was extracted. This difference introduces an error or drift in the synchronism of the ancillary data relative to the original timing of such ancillary data in the systems layer stream before processing. It is desired to maintain such a synchronism error or drift within a tolerable range. In a worst case scenario, ancillary data located in the original systems layer stream at one end of a temporal locale (e.g., at the latest time or end of the temporal locale) is inserted into the new processed systems layer stream at the opposite end of the temporal locale (e.g., the earliest time, or beginning of the temporal locale). As can be appreciated, the maximum error or drift in synchronism is approximately equal to the duration of the temporal locale. Therefore, by increasing the frequency of synchronization points, the duration of temporal locales is shortened and the maximum possible error or drift in synchronism of ancillary data is reduced. In any event, it is generally preferred for the frequency of occurrence of the type of synchronization point to be at least equal to the frequency of occurrence of the ancillary data to be retimed or re-synchronized.

Considering these criteria, there are two classes of synchronization points that can be used. One is a physical synchronization point, which corresponds to a predefined, unvarying sequence of bits or code which can be identified in the bitstream. For example, in the case of an MPEG-1, MPEG-2 or MPEG-4 elementary stream, any start code can serve as a synchronization point. In the MPEG-1, MPEG-2 and MPEG-4 standards, each start code is a 32 bit code comprising a 23 bit start code prefix 0000 0000 0000 0000 0000 0001 followed by one byte that distinguishes the type of start code from each other type. The following are examples of MPEG-2 video start codes, and the distinguishing byte that identifies them:

TABLE 1

| Name | Start code identifier |
|---|---|
| picture_start_code | 00 |
| slice_start_code | 01 - AF |
| user_data_start_code | B2 |
| sequence_header_code | B3 |
| extension_start_code | B5 |
| sequence_end_code | B7 |
| group_start_code | B8 |

Of these, the group_start_code, the picture_start_code and the slice_start_code are typically good candidates for use as synchronization points. The group_start_code immediately precedes a group of pictures (GOP) within the video elementary stream. GOP's are “entry points” i.e., random access points, at which a decoder can arbitrarily start decoding, e.g., in a trick mode operation (jump, fast forward, rewind, etc.). Such an entry point may also be used by a decoder when it is powered on, or otherwise caused to tune to, a systems layer stream which is already in the middle of transfer. The picture_start_code is required by MPEG-1, MPEG-2 and MPEG-4 (and optional in MPEG-4 part 10) to be present at the start of each encoded video picture. Depending on the type of stream processing, this start code will also be present in the video elementary stream after stream processing. Also, this start code is synchronized to the start of a video picture and therefore coincides with the true decoding time and presentation time of the picture (whether or not DTSs or PTSs representing the decoding time and/or presentation time are present in the systems layer stream). Generally speaking, picture_start_codes will occur at a higher frequency than group_start_codes. The slice_start_code is also a good candidate. The slice_start_code is provided at the beginning of a slice, which (according to MPEG-1 and MPEG-2) includes all or part of the macroblocks of a given macroblock row of a video picture. (According to H.264, a slice can span more than one macroblock row.) The particular macroblock row to which the slice_start_code pertains can be easily determined using a well-defined formula. Therefore, the slice_start_code coincides with the time of presentation of a decoded version of the corresponding slice location in the video picture. Generally speaking, slice_start_codes will occur at a much higher frequency that picture_start_codes. Typically, there will be at least one slice per macroblock row, and a device that parses the elementary stream can determine the particular horizontal offset within the macroblock row at which the slice occurs. Therefore, the correspondence of the slice to the display time of information represented by the slice can be determined.

In some circumstances, it is difficult to choose an actual physical synchronization point that meets all of the above criteria. For example, in transcoding an MPEG-2 video signal to an MPEG-4 video signal, slices may appear in the MPEG-2 video signal but not the MPEG-4 video signal. In the alternative, the physical synchronization points that do appear might not recur at a sufficiently high enough frequency to provide a good reference for retiming or re-synchronizing the ancillary data. For example, picture start codes might not occur frequently enough to provide a sufficiently accurate reference by which ancillary data, such as PCRs, can be resynchronized. In such a case, it may be desirable to choose a virtual synchronization point. Unlike a physical synchronization point, a virtual synchronization point might not correspond to a very explicitly predetermined code or sequence of bits. Rather, a virtual synchronization point might correspond to a bit, or sequence of bits, representing a well-defined, deterministically identifiable layer of the elementary stream, which may start with an arbitrary bit pattern not known ahead of time. For example, MPEG-2 video slices contain individual macroblocks, and each macroblock starts with a variable length code indicating the macroblock address increment. The variable length code representing the macroblock address increment is chosen from a table of multiple macroblock address increment codes. Such a variable length code can be easily identified, but it is not known ahead of time which specific one will be encountered; the specific code encountered will depend on the number of skipped macroblocks between the last encoded macroblock and the current encoded macroblock. Nevertheless, the location of the macroblock in a video picture can be determined with absolute accuracy and therefore so can the corresponding display time of the macroblock. Therefore, the start of a macroblock can provide a very effective virtual synchronization point because, generally, they occur at an even higher frequency than slices.

It should be noted that stream processing can include and combination of transcoding, editing or splicing. These types of processing may change the amount of information in an elementary stream between two successive synchronization points. For example, in transcoding, the amount of information: (a) in a video picture, between video picture start codes; (b) in a slice, between slice start codes; or (c) in a sequence of one or more macroblocks, between successive macroblock address increment codes, can be changed. Likewise, consider the case of a splice where several video pictures are inserted between two video pictures of an original elementary stream. By definition, the amount of elementary stream information between the picture start code of the original video picture preceding the insert, and the picture start code of the original video picture following the insert, will increase. Nevertheless, the synchronization points will survive the stream processing operation. Moreover, systems layer stream information that was temporally located at a particular vicinity of one synchronization point in the original elementary stream should be temporally located as close as possible to that same synchronization point in the new systems layer stream containing the processed elementary stream.

As can be appreciated from the discussion above, many factors influence the choice of types of synchronization point to be used to retime or re-synchronize the ancillary data. According to one embodiment, the choice of synchronization point type(s) to be used is predetermined and remains fixed during operation. However, it is preferable to adapt the choice of synchronization point type, either once for each elementary stream, or dynamically in real-time, to suit the particular stream processing, types of elementary stream(s) to be processed and types of ancillary data to be retimed or re-synchronized. Illustratively, the choice of synchronization type may be chosen by an operator or automatically selected by the system according to the invention. Generally, automatic adaptation is not only attractive (to minimize operator training and dependence) but also feasible. The reasons is that the stream processor, and other devices that work with it, must be able to parse the incoming systems layer and elementary streams as well as to format them. It is not too much effort to also provide circuitry or software instructions which can determine the relative frequencies of occurrence of different types of ancillary data, synchronization points, etc. to facilitate automatic selection of synchronization point type(s). Note also that more than one type of synchronization point type may be used simultaneously; the synchronization point types need only occur serially in the elementary stream. In addition, it is sometimes desirable to use both physical synchronization points, such as start codes, and virtual synchronization points, such as the points in the bit stream corresponding to macroblocks, simultaneously. This would ensure that synchronization points occur in the bit stream with a sufficiently high frequency of occurrence and regularity.

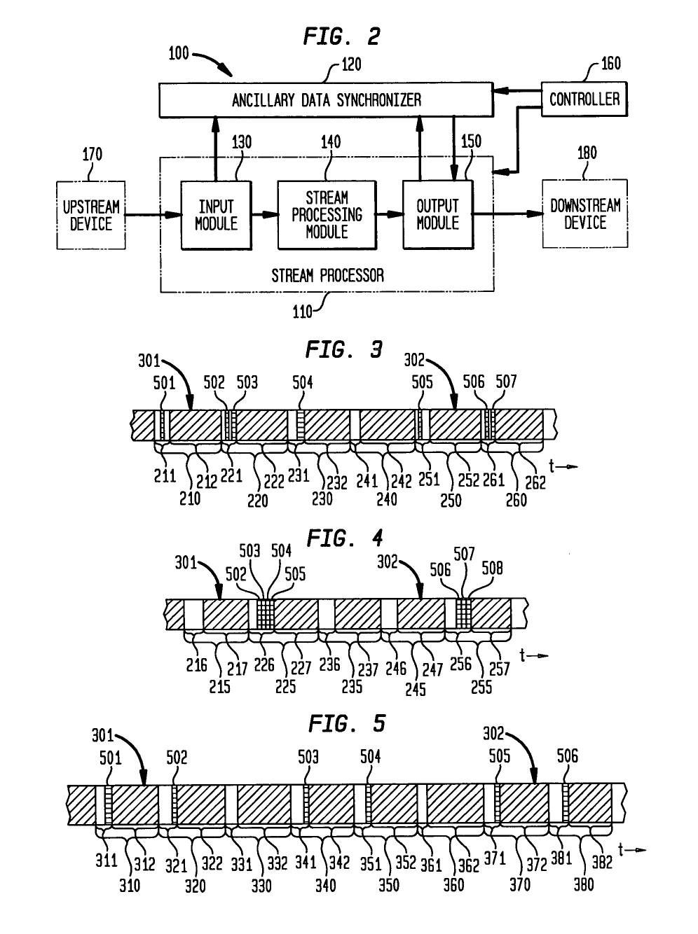

FIG. 2 shows an illustrative system 100 according to an embodiment of the invention. Illustratively, such a system may be implemented using a suitably programmed network of one or more Mediaplex-20™ or Source Media Routers™ available from SkyStream Networks Inc., a company located in Sunnyvale Calif. The basic architectures of these devices are described in U.S. patent application Ser. No. 10/159,787 and U.S. Pat. No. 6,351,474, respectively. As described in these documents, other devices, such as storage apparatuses, computers, etc. can also be connected as needed. In the illustration of FIG. 2, the system 100 is shown as including an upstream device 170, a stream processor 110, an ancillary data synchronizer 120, a controller 160 and a downstream device 180. Each of these devices may be contained in the same unit, e.g., the same Mediaplex20™ or the same Source Media Router™. Alternatively, one or more of the devices 170, 110, 120, 160 and 180 may be separate devices.

A systems layer stream, such as a transport stream containing one or more elementary streams of one or more programs, is outputted from the upstream device 170 to the stream processor 110. Indeed, a sequence (or graph) of more than one upstream device 170 can be provided in the system 100. Each upstream device 170 may be any suitable device typically found in the signal flow for a systems, program or elementary stream signal (or signal derived therefrom) such as an encoder, a conventional stream processor (e.g., splicer, transcoder, editor, etc.), a stream processor 100 according to the invention, a remultiplexer, a very simple relay device (e.g., a transmitter, a receiver, a modulator, a demodulator, a demultiplexer, a multiplexer), etc. The stream processor 110, in turn, can be implemented with one or more Mediaplex20s™ or Source Media Routers™.

The stream processor 110 includes an input module 130, which parses the systems layer(s), e.g., the transport and PES stream layers, and the elementary stream layer(s) of the input transport stream. Specifically, the input module 130 identifies ancillary data of interest of the systems layer(s) and provides the identified ancillary data to the ancillary data synchronizer 120. The input module 130 also identifies each synchronization point of the elementary that is processed by the stream processor 110. For example, the input module 130 can produce a signal indicating a particular synchronization point and all of the ancillary data (of interest) detected at a temporal location of the inputted systems layer stream in a vicinity to that synchronization point. In the alternative, the input module 130 can simply output all of the ancillary data detected at a synchronization point without indicating the specific identity of the synchronization point. As described below, this is possible because synchronization points are expected to occur in the same sequential order in the new systems layer stream outputted from the stream processor 110 as they occur in the inputted systems layer stream. In the case that no ancillary data is detected for a certain synchronization point, the input module 130 can also output a very simple signal indicating that no ancillary data was detected for the most recently identified synchronization point. In the alternative, if no ancillary data of interest is detected, the input module 130 can simply output no data at all.

The identification of ancillary data and synchronization points by the input module 130 may be integrated into other parsing steps carried out to support stream processing performed by the processing module 140. For example, when transcoding an elementary stream, the elementary stream must be at least partially decoded, which requires at least partially parsing the inputted systems layer and elementary streams to identify coded data to be modified.

The ancillary data synchronizer 120 stores the identified ancillary data for efficient and quick retrieval, e.g., in a memory circuit. Illustratively the ancillary data synchronizer 120 can be controlled to retrieve all of the ancillary data associated with a specific synchronization point. For example, the ancillary data synchronizer 120 may maintain a look up table that correlates each appropriately detected synchronization point with the ancillary data that corresponds to it. Alternatively, it is known that each synchronization point detected in the inputted transport stream will also be present in the transport stream to be outputted from the stream processor 110 and will occur in the same order. As such, the ancillary data synchronizer 120 could simply store each group of ancillary data separately in a queue or linked list form of structure. In addition, if it is expected that no ancillary data may be detected for some synchronization points, an empty queue slot may be provided for such a synchronization point or some other information may be stored indicating how many synchronization points did not have corresponding ancillary data.

The processing module 140 performs the requisite stream processing on the elementary stream such as transcoding, splicing or editing. The input may be the elementary stream, a partially parsed elementary stream, a partially parsed systems layer stream, etc. For example, it may be convenient at the input module 130 to simply extract each transport packet carrying the elementary stream to be stream processed and provide such transport packets to the processing module 140. (Other transport packets may be forwarded directly to the output module 150 for insertion into the new transport layer stream produced by the stream processor 110 or may be inserted by another element following the output module 150.) In the case of splicing or editing, additional systems layer streams or elementary streams are typically provided for selective combination with the elementary stream of the inputted systems layer signal to be processed. They are omitted from FIG. 2 for sake of clarity. The output of the processing module 140 illustratively is simply a new encoded elementary stream, which contains certain sequences of bits that have been modified. In particular, the processing module 140 may modify the amount of information between any two successive synchronization points.

The output module 150 receives the processed elementary stream outputted from the processing module 140 and constructs a systems layer stream that carries it. For example, in the case of an MPEG-2 transport stream, the output module 150 may divide the elementary stream into segments and attach a PES packet header to each such segment. The output module 150 may then divide each PES packet into segments and attach a transport packet header to each PES packet segment. The output module 150 is able to detect the occurrence of each synchronization point in the new processed elementary stream and to retrieve from the ancillary data synchronizer 140, the ancillary data corresponding to that respective synchronization point. The detection of synchronization points may be trivial; the processing module 140 may output the elementary stream to the output module 150 in spurts containing one synchronization point and all of the elementary stream data, in sequence, up until, but excluding, the next synchronization point. (Of course, the spurt of elementary stream data could, in the alternative, contain all of the elementary stream data following a synchronization point up until and including the next successive synchronization point.) In the alternative, the input module 130 can communicate a signal or other information to the output module 150 for identifying the synchronization points. However, the output module 150 can also simply parse the processed elementary stream to identify the synchronization points. In response, the output module 150 issues a request to the ancillary data synchronizer 120 for the ancillary data associated with each synchronization point. The ancillary data synchronizer 120 responds by retrieving the appropriate ancillary data and providing it to the output module 150. The output module 150 then inserts the ancillary data into the new systems layer stream that carries the processed elementary stream data. The new systems layer stream is then outputted to a sequence (or graph) of one or more downstream devices 180. Each downstream device 180 may be any suitable device typically found in the signal flow for a systems, program or elementary stream signal (or signal derived therefrom) such as a conventional stream processor, another stream processor according to the invention, a remultiplexer, a decoder (that decodes and processes the elementary stream), a simple relay device (e.g., a receiver, transmitter, modulator, demodulator), etc.

The output module 150 can insert ancillary data into a single transport packet, e.g., the transport packet header and/or PES packet header. However, this is not always possible or desirable. For example, the ancillary data could be several instances of certain data, e.g., a PTS, and a single transport packet header and/or PES packet header may only have capability for carrying one instance of such data, e.g., one PTS field per PES packet header. Alternatively, it may be desirable to disperse the ancillary data of the sequence of transport packets between the synchronization points in an effort to average the error or drift in synchronization introduced into the ancillary data.

Also shown is an optional controller 160. The controller 160 can configure or even dynamically adapt the operations of the ancillary data synchronizer 120, the stream processor 110 or the elements thereof (i.e., the input module 130, the processing module 140 or the output module 150). In particular, the controller 160 can change the stream processing of the processing module 140, configure the input module 130 to search for particular synchronization points (specifically to search for one or more particular types of synchronization points), configure the ancillary data stream analyzer 120 to store ancillary data in a certain fashion and configure the output module 150 to generate a particular type of systems layer stream or to follow a particular strategy for distributing elementary stream data segments and ancillary data over the systems layer segments.

In retiming or re-synchronizing the ancillary data, the following overall procedure may be followed. First, the system 100 is appropriately configured, e.g., by the controller 160. For example: (a) the type or types of ancillary data to be retimed or resynchronized, (b) the strategy to be used for relocating such ancillary data between synchronization points in the output system layer stream, (c) the frequency of occurrence of the ancillary data to be retimed or re-synchronized, (d) the syntax and semantic of the input elementary stream to be processed, (e) the type of stream processing to be performed on the elementary stream and (f) the resulting syntax and semantics of the processed elementary stream are determined and configured as necessary in the input module 130, processing module 140, output module 150 and ancillary data synchronizer 120. Next, the types of synchronization points are selected which occur at sufficient frequency in the input elementary stream (prior to stream processing) and the output elementary stream (after stream processing) to enable retiming or re-synchronization of the ancillary data expected in the systems layer stream carrying the input elementary stream. The original systems layer stream is then inputted to the input module 130 (from the upstream device 170). The input module 130 parses the inputted original systems layer stream to identify each synchronization point and the ancillary data temporally located in the input original systems layer stream in a vicinity of the synchronization point. The input module 130 then transfers the identified ancillary data to the ancillary data synchronizer 120 for storage.

Illustratively, it is convenient to collect ancillary data into groups for retiming on a temporal locale basis, where the temporal locales are defined as shown in the systems layer stream of FIG. 3. FIG. 3 shows a portion of a systems layer stream with systems layer segments 210, 220, 230, 240, 250 and 260. Each segment 210, 220, 230, 240, 250 and 260 has a systems stream specific sub-segment (such as a packet header) 211, 221, 231, 241, 251 and 261, respectively, and a portion of an elementary stream (e.g., in a packet payload) 212, 222, 232, 242, 252 and 262, respectively. For sake of clarity, it is assumed that the systems layer stream is carrying only a single elementary stream, such as a compressed video signal, although, in a more general case, the systems layer stream will carry interleaved segments of multiple elementary streams (e.g., segments of a video signal and segments of an audio signal). As such, each segment 212, 222, 232, 242, 252 and 262 is part of the same elementary stream. Also shown in FIG. 3 are specific ancillary data of interest 501 in systems stream sub-segment 211, 502 and 503 in systems stream sub-segment 221, 504 in systems stream sub-segment 231, 505 in systems stream sub-segment 251 and 506 and 507 in systems stream sub-segment 261.

Two synchronization points 301 and 302 are also shown in FIG. 3 which define a temporal locale within the elementary stream. For convenience herein, the temporal locale is defined as a sub-sequence of the elementary stream data including, synchronization point 301, the elementary stream data in elementary stream segment 212 later in time (to the right, in FIG. 3) than the synchronization point 301, the elementary stream segments 222, 232, 242 and the portion of elementary stream segment 252 earlier in time than (i.e., to the left of) the synchronization point 302. (That is the temporal locale is defined, in sequence, as the first detected synchronization point and the elementary stream data up until the next synchronization point. Of course, in the alternative, the first synchronization point could have been omitted and the second synchronization point included.) All of the ancillary data 502, 503, 504 and 505 carried in the systems layer segments 220, 230, 240 and 250 between the synchronization points 301 and 302 are collected as a group and associated with the first synchronization point 301.

The processing module 140 stream processes the elementary stream and outputs a new processed elementary stream. FIGS. 4 and 5 show two examples of the results of processing the elementary stream of FIG. 3. For convenience, the rate of the systems layer stream is presumed to be constant for sake of clarity. However, this need not be the case.

In FIG. 4, a portion of a processed systems layer signal is shown with systems layer segments 215, 225, 235, 245 and 255, having systems layer specific sub-segments 216, 226, 236, 246 and 256, respectively and carrying segments of an elementary stream 217, 227, 237, 247 and 257, respectively. Furthermore, in FIG. 4, it is assumed that the amount of information in the original elementary stream information sequence of FIG. 3 (i.e., the synchronization point 301, the portion of segment 212 temporally later than the synchronization point 301, segments 222, 232, 242 and the portion of the segment 252 temporally earlier than the synchronization point 302) has been reduced to produce a new processed elementary stream sequence. Such a reduction of amount of information may be the result of a bit-rate reduction transcoding or an edit operation that reduces the amount of information in the original elementary stream sequence 401. The new (information amount reduced) elementary stream sequence in FIG. 4 includes the synchronization point 301, the portion of processed elementary stream segment 217, later than the synchronization point 301, the processed elementary stream segments 227 and 237, and the portion of processed elementary stream segment 247 earlier than the synchronization point 302.

In FIG. 5, a portion of a processed systems layer signal is shown with systems layer segments 310, 320, 330, 340, 350, 360, 370 and 380, having systems layer specific sub-segments 311, 321, 331, 341, 351, 361, 371 and 381, respectively, and carrying segments of an elementary stream 312, 322, 332, 342, 352, 362, 372 and 382, respectively. Furthermore, in FIG. 5, it is assumed that the amount of information in the original elementary stream information sequence of FIG. 3 (i.e., the synchronization point 301, the portion of segment 212 temporally later than the synchronization point 301, segments 222, 232, 242 and the portion of the segment 252 temporally earlier than the synchronization point 302) has been increased to produce a new processed elementary stream. Such an increase may be the result of inserting additional elementary stream information into the original elementary stream information sequence as a result of a splice operation. The new (information amount increased) elementary stream sequence in FIG. 5 includes the synchronization point 301, the portion of processed elementary stream segment 312, later than the synchronization point 301, the processed elementary stream segments 322, 332, 342, 352, and 362, and the portion of processed elementary stream segment 372 earlier than the synchronization point 302.

The output module 150 receives the processed elementary stream and produces a new systems layer stream carrying the new processed elementary stream. As the output module 150 detects each synchronization point 301 and 302, the output module 150 issues a request to the ancillary data synchronizer 120 to obtain the requisite ancillary data. As above, the ancillary data is provided in groups associated with the temporal locales for which they were detected. For instance, suppose the output module 150 issues a request for all the ancillary data to be located temporally in the vicinity of the first synchronization point 301. In response, the ancillary data synchronizer 120 returns the ancillary data 502, 503, 504 and 505 in the temporal locale corresponding to the synchronization point 301. The output module 150 then inserts the retrieved ancillary data into the new systems layer segments that carry the first synchronization point 301 and the new processed version of the sequence of elementary stream information. As shown in FIG. 5, the ancillary data 502, 503, 504 and 505 may be distributed over multiple ones of the processed systems layer segments, e.g., segments 320, 340, 350 and 370, in compliance with the governing syntax(es) of the systems layer stream. In the alternative, as shown in FIG. 4, all of the ancillary data 502, 503, 504 and 505 may be inserted into one systems layer segment, e.g., the systems layer segment 225, so long as the resulting systems layer stream complies with the governing syntax(es). This specific systems layer segment into which the ancillary data 502-505 is inserted can be suitably chosen as any systems layer segment provided that the actual insertion point is between the first synchronization point 301 and the second synchronization point 302.

The invention has been described above with reference to specific illustrative embodiments. Those having ordinary skill in the art may devise numerous alternative embodiments without departing from the spirit scope of the following claims.

1. A method of processing an elementary stream that is ultimately capable of being consumed according to a predefined and deterministic schedule relative to a particular system time clock of a program that comprises the elementary stream, and which system time clock can be recovered from a systems layer stream that carries the elementary stream, the method comprising the steps of:
(a) identifying first and second synchronization points of an elementary stream, the first and second synchronization points being separated by a particular sequence of information in the elementary stream carried in an original systems layer stream comprising a series of systems layer stream segments, each systems layer stream segment comprising a systems layer specific sub-segment of information and one elementary stream sub-segment, of a plurality of sub-segments of elementary stream information into which the elementary stream is divided, wherein one or more systems layer information sub-segments, of a sub-series of the systems layer stream segments that carry the first synchronization point, and the particular sequence of elementary stream information, carry particular ancillary data,
(b) processing the elementary stream to produce a modified sequence of elementary stream information to be carried between the first and second synchronization points, having a different amount of information than the particular sequence of information, and
(c) inserting into a new systems layer stream, a series of one or more new systems layer stream segments carrying the first synchronization point, and the modified sequence of elementary stream information, at least one of the new systems layer stream segments comprising a systems layer information sub-segment containing the particular ancillary data,
wherein each synchronization point is a type of sequential location of the elementary stream: (1) which recurs continually throughout the elementary stream; (2) is synchronized in time to the systems time clock of the program comprising the elementary stream; and (3) is always present in an elementary stream both prior to, and after, the processing.

2. The method of claim 1 wherein the step of inserting further comprises distributing the particular ancillary data over multiple ones of the new systems layer stream segments.

3. The method of claim 1 wherein the step of inserting further comprises inserting the particular ancillary data into a single one of the new systems layer stream segments.

4. The method of claim 1 wherein the frequency of occurrence of the synchronization points in the elementary stream is at least equal to the frequency of occurrence of one type of ancillary data comprised in the particular ancillary data.

5. The method of claim 1 further comprising the step of dynamically choosing one or more particular types of synchronization points which are expected to occur with sufficient frequency to use as reference points for locating the particular ancillary data in the new transport stream.

6. The method of claim 1 further comprising the step of processing the original systems layer stream prior to identifying the first and second synchronization points.

7. The method of claim 1 further comprising the step of processing the new systems layer stream after inserting the new systems layer segments.

8. The method of claim 1 further comprising the steps of:
prior to the step of inserting, identifying the particular ancillary data carried in the same systems layer stream segments of the original systems layer stream that also carry the particular elementary stream sequence, and storing the identified particular ancillary data, and
the step of inserting including the steps of identifying the occurrence of the first synchronization point in the elementary stream to be processed, retrieving the particular ancillary data, and generating the systems layer information sub-segment of the new systems layer segments containing the retrieved ancillary data,
wherein an error in synchronism of the particular ancillary data with the system time clock of the program comprising the elementary stream is reduced by locating the ancillary data within the new systems layer stream at a similar vicinity relative to one of the first or second synchronization points as in the original systems layer stream.

9. The method of claim 8 wherein a maximum error in synchronism is directly related to a duration of a temporal locale between the first and second synchronization points.

10. The method of claim 1 wherein at least one of the first and second synchronization points is a code contained within the elementary stream.

11. The method of claim 1 wherein at least one of the first and second synchronization points is a virtual point of the elementary stream corresponding to a definite identifiable portion of the elementary stream of varying data value that is consumed at a particular scheduled time relative to the system time clock of the program comprising the elementary stream.

12. The method of claim 1 wherein the synchronization points delimit portions of the elementary stream to be consumed at a particular scheduled time relative to the systems time clock of the program comprising the elementary stream.

13. The method of claim 12 wherein the elementary stream is consumed, the consumption comprising removing the delimited elementary stream portion from a specific buffer at a particular scheduled time relative to the systems time clock.

14. The method of claim 12 wherein the elementary stream is consumed, the consumption comprising decoding the delimited elementary stream portion at a particular scheduled time relative to the systems time clock.

15. The method of claim 12 wherein the elementary stream is consumed, the consumption comprising presenting information represented by the delimited elementary stream portion at a particular scheduled time relative to the systems time clock.

16. The method of claim 1 comprising, for at least one second, successive sequence of information in the elementary stream carried in the original systems layer stream, following the particular sequence of information in the elementary stream, repeating the steps of: (a) identifying first and second synchronization points; (b) processing the elementary stream; and (b) inserting a series of one or more new systems layer segments containing particular ancillary data into a new systems layer stream.

17. The method of claim 16 wherein at least one synchronization point is a code contained within the elementary stream and wherein at least one synchronization points is a virtual point of the elementary stream corresponding to a definite identifiable portion of the elementary stream of varying data value that is consumed at a particular scheduled time relative to the system time clock of the program comprising the elementary stream.
